(19) United States
(12) Patent Application Publication
(10) Pub. No.: US 2021/0286507 A1
(43) Pub. Date: Sep. 16, 2021

(54) SYSTEM ENABLING MAGNIFICATION OF A VIDEO STREAM DURING AN ONLINE EVENT

(71) Applicant: Kishore Daggubati, Danville, CA (US)

(72) Inventor: Kishore Daggubati, Danville, CA (US)

(21) Appl. No.: 17/331,683

(22) Filed: May 27, 2021

(51) Int. Cl. G06F 3/0484; G06F 3/16

(52) U.S. Cl. CPC G06F 3/04847; G06F 3/165; G06F 2203/04806; G06F 2203/04805; G06F 3/04842

(57) ABSTRACT

A system enabling magnification of a video stream during an online event. The system comprises a first data processing system and a second data processing system. The first data processing system comprises a first processor module and a first digital client, wherein the first processor module causes the first digital client to share at least a first video stream with the second data processing system. The second data processing system comprises a second processor module, a second digital client and a second digital client display interface, wherein in the second digital client comprises a second digital client display interface, wherein the second digital client displays in the second digital client display interface, visual content of the first video stream in a display window. The second processor module is configured to receive an instruction from a user associated with the second data processing system, wherein the instruction comprises information related to a region of the first video stream to be magnified. Further, the second processor module is configured to magnify the region of the first video stream based on the instruction provided by the user and cause the second digital client display interface to display the magnified region of the first video stream in the display window.

### BACKGROUND

### Field of Invention

The disclosed subject matter relates to the field of online meeting. More particularly, but not exclusively, the subject matter relates to magnification of video stream during an online meeting.

### Discussion of Related Field

The rapid rise in the internet usage across the globe has reshaped the way people connect with each other. Moreover, with a good internet connection, video conferencing has made communication over the internet feel as real as communicating in person. The video conferencing has been typically used in business meetings, tele medicines, recruitments and so forth. However, it shall be noted that, off-late, the video conferencing has found its application beyond conventional applications. As an example, video conferencing is now being used to conduct webinars for online teaching, live streaming of weddings, live streaming of rallies so on and so forth.

In such applications, typically a host or a streaming device streams one or more video streams with the participants of the online event. The participants are able to view the streamed video streams using devices such as a mobile phone, computer and so forth. Typically, a streamed video may cover a large area, in which case, the participants may not be able to see fine details of covered in the video. As an example, a video stream may cover a party hall and the user may want to know the brand of a loud speaker but is unable to clearly see the brand name. In such cases, a magnification feature to magnify the particular region of the video to clearly see the brand name of the loud speaker may be desirable.

It shall be noted that, conventional video streaming tools do not offer the ability to magnify a video stream as required by the user.

In view of the foregoing, it is apparent that there is a need for an improved video conferencing system enabling magnification of the video stream.

### SUMMARY

In one embodiment, a system enabling magnification of a video stream during an online event is disclosed. The system comprises a first data processing system and a second data processing system. The first data processing system comprises a first processor module and a first digital client, wherein the first processor module causes the first digital client to share at least a first video stream with the second data processing system. The second data processing system comprises a second processor module, a second digital client and a second digital client display interface, wherein in the second digital client comprises a second digital client display interface, wherein the second digital client displays in the second digital client display interface, visual content of the first video stream in a display window. The second processor module is configured to receive an instruction from a user associated with the second data processing system, wherein the instruction comprises information related to a region of the first video stream to be magnified. Further, the second processor module is configured to magnify the region of the first video stream based on the instruction provided by the user and cause the second digital client display interface to display the magnified region of the first video stream in the display window.

### BRIEF DESCRIPTION OF DRAWINGS

Embodiments are illustrated by way of example and not limitation in the figures of the accompanying drawings, in which like references indicate similar elements and in which:

FIG. 1 illustrates a system 100 for enabling magnification of a video stream in an online event, in accordance with an embodiment.

FIG. 2 is a block diagram illustrating a first data processing system 102, in accordance with an embodiment.

FIG. 3 is a block diagram illustrating a second data processing system 104, in accordance with an embodiment.

FIG. 4 is a block diagram illustrating a remote server 106, in accordance with an embodiment.

FIG. 5 illustrates an architecture of a system 100 for magnification of a video stream during an online event, in accordance with an embodiment.

FIG. 6 is a flowchart of establishing a connection between the first data processing system 102 and the second data processing system 104.

FIG. 7 is a flow chart of magnification of a region of a first video stream 110, in accordance with an embodiment.

FIG. 8 is a flow chart of magnification of a region of a video stream, in accordance with an embodiment.

FIGS. 9A and 9B illustrates the second digital client display interface during the magnification of a region of a first video stream 110, in accordance with an embodiment.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

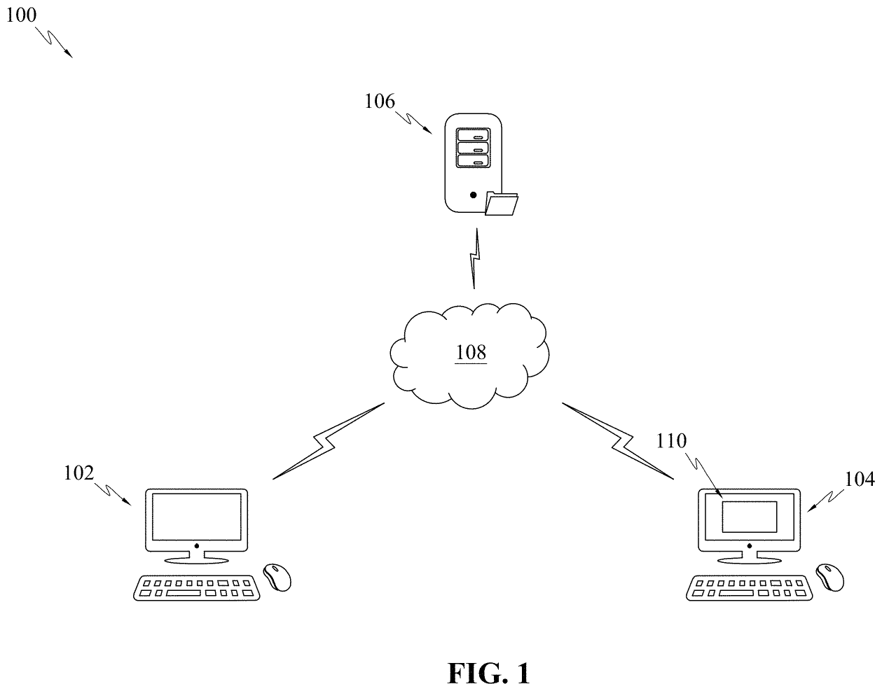

FIG. 1 illustrates a system 100 for enabling magnification of a video stream in an online event, in accordance with an embodiment. The system 100 comprises a first data processing system 102, a second data processing system 104, a server 106 and a communication network 108. The first data processing system 102 may be configured to share with the second data processing system 104 a first video stream 110 via the server 106 and the communication network. The second data processing system 104 may be associated with a user.

In one embodiment, the first video stream 110 may comprise an audio component and a video component. The video component and the audio component of the first video stream 110 shared by the first data processing system 102 may be obtained from a first camera and a first microphone respectively of the first data processing system 102.

In one embodiment, the first data processing system 102 and the second data processing system 104 may include, but not limited to, desktop computer, laptop, smartphone or the like.

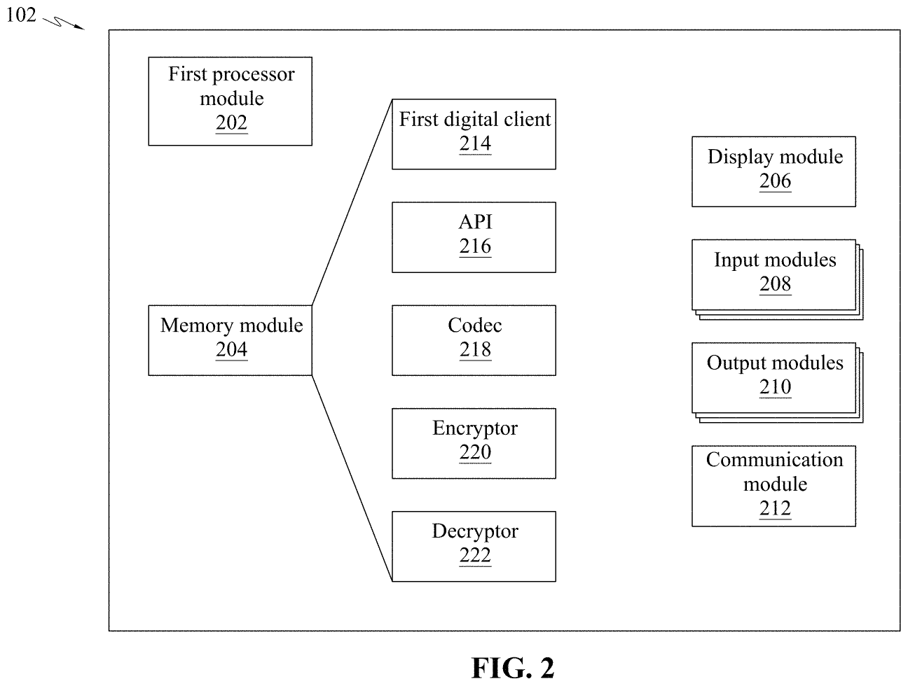

FIG. 2 is a block diagram illustrating a first data processing system 102, in accordance with an embodiment. The first data processing system 102 may comprise a first processor module 202, a memory module 204, a display module 206, input modules 208, output modules 210 and a communication module 212.

The first processor module 202 may be implemented in the form of one or more processors and may be implemented as appropriate in hardware, computer-executable instructions, firmware, or combinations thereof. Computer-executable instruction or firmware implementations of the first processor module 202 may include computer-executable or machine-executable instructions written in any suitable programming language to perform the various functions described.

The memory module 204 may include a permanent memory such as hard disk drive, may be configured to store data, and executable program instructions that are implemented by the processor module. The memory module 204 may be implemented in the form of a primary and a secondary memory. The memory module 204 may store additional data and program instructions that are loadable and executable on the first processor module 202, as well as data generated during the execution of these programs. Further, the memory module 204 may be volatile memory, such as random-access memory and/or a disk drive, or non-volatile memory. The memory module 204 may comprise of removable memory such as a Compact Flash card, Memory Stick, Smart Media, Multimedia Card, Secure Digital memory, or any other memory storage that exists currently or may exist in the future.

In an embodiment, the memory module 204 may further comprise a first digital client 214, an Application Programming Interface (API) 216, a codec 218, an encryptor 220 and a decryptor 222. The first digital client 214 may be a web browser or a software application enabling multiple screen sharing simultaneously, wherein the first digital client 214 may further comprise a first digital client display interface. The first digital client interface may enable the interaction of the user with the data processing system. The codec 218 may include computer-executable or machine-executable instructions written in any suitable programming language to perform compress outgoing data and decompress incoming data. The encryptor 220 may encrypt the data being sent and decryptor 222 may decrypt the incoming data.

The display module 206 may display an image, a video, or data to a user. For example, the display module 206 may include a panel, and the panel may be an LCD, LED or an AM-OLED.

The input modules 208 may provide an interface for input devices such as keypad, touch screen, mouse and stylus among other input devices. In an embodiment, the input modules 208 includes a camera and a microphone.

The output modules 210 may provide an interface for output devices such as display screen, speakers, printer and haptic feedback devices, among other output devices.

The communication module 212 may be used by the first data processing system 102 to communicate with the remote server 106. The communication module 212, as an example, may be a GPRS module, or other modules that enable wireless communication.

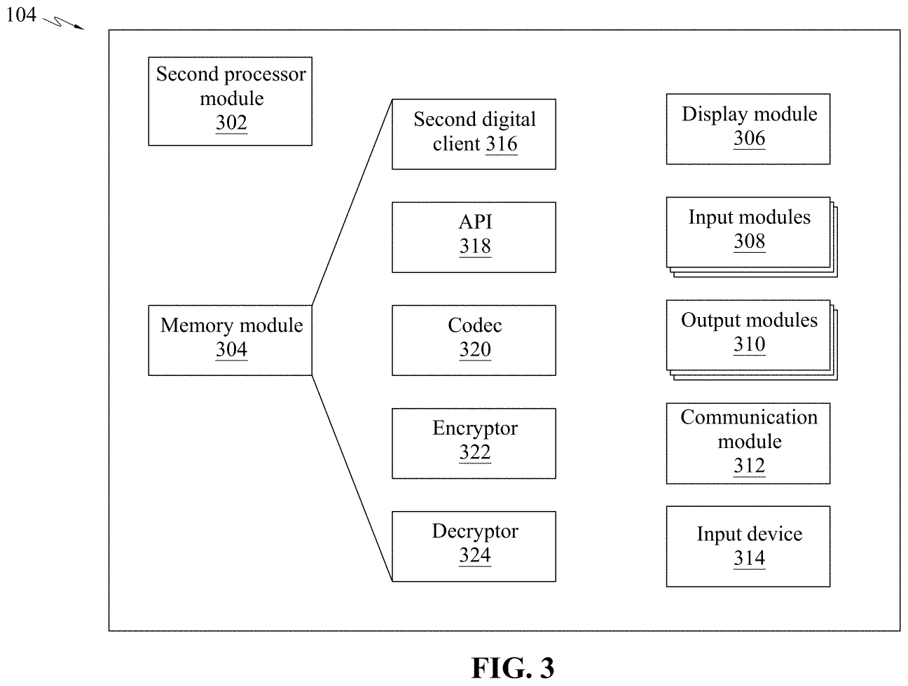

FIG. 3 is a block diagram illustrating a second data processing system 104, in accordance with an embodiment. The second data processing system 104 may comprise modules that are similar to the modules present in the first data processing system 102. The second data processing system 104 may comprise an input device 314, wherein the input device 314 may be configured to enable a user associated with the second data processing system 104 to provide inputs to the second data processing.

In one embodiment, the input device 314 may be a mouse, a touch screen, a keyboard or the like.

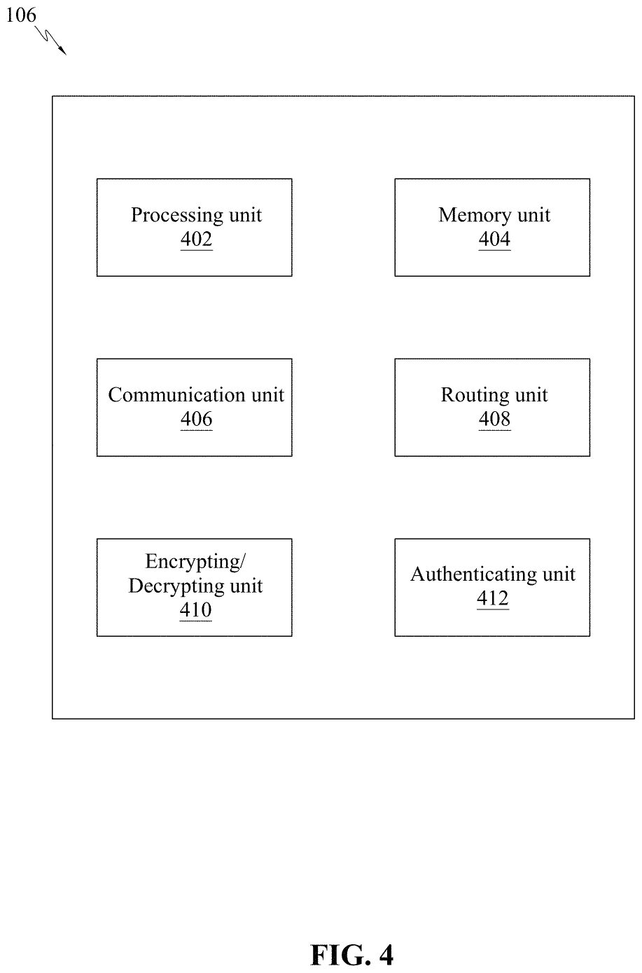

FIG. 4 is a block diagram illustrating a remote server 106, in accordance with an embodiment. The remote server 106 may comprise a processing unit 402, a memory unit 404, a communication unit 406, a routing unit 408, an encrypting/decrypting unit 410 and an authenticating unit 412.

The processing unit 402 may be implemented in the form of one or more processors and may be implemented as appropriate in hardware, computer-executable instructions, firmware, or combinations thereof. Computer-executable instruction or firmware implementations of the processing unit 402 may include computer-executable or machine-executable instructions written in any suitable programming language to perform the various functions described.

The memory unit 404 may include a permanent memory such as hard disk drive, may be configured to store data, and executable program instructions that are implemented by the processor module.

The communication unit 406 may be used by the remote server 106 to communicate with the first data processing system 102 and the second data processing system 104. The communication unit 406, as an example, may be a GPRS module, or other modules that enable wireless communication.

The routing unit 408 may enable identification of data processing systems to which the data must be transmitted.

The encrypting/decrypting unit 410 may encrypt the incoming data from each of the data processing systems and decrypt the outgoing data from the remote server 106.

The authenticating unit 412 may authenticate each of the data processing systems before establishing a connection.

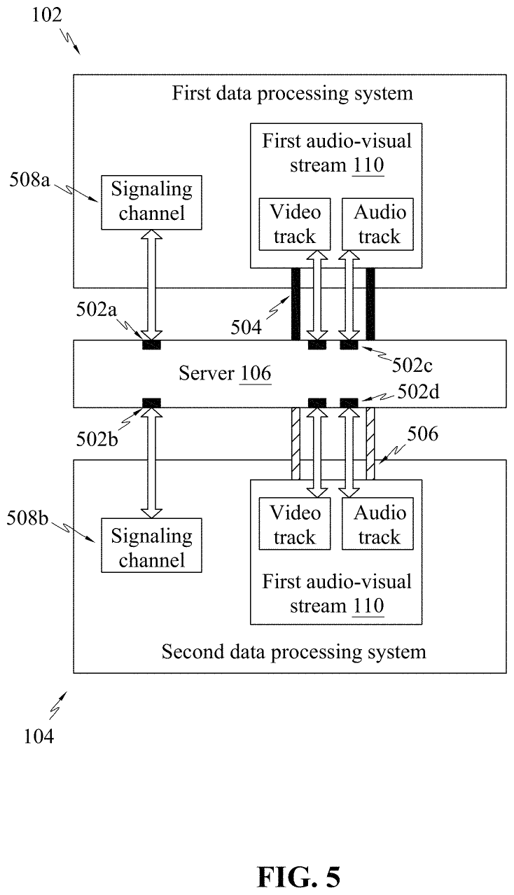

FIG. 5 illustrates an architecture of a system 100 for magnification of a video stream during an online event, in accordance with an embodiment. The first data processing system 102 and the second data processing system 104 may establish a connection with the remote server 106 via a UDP socket (502a and 502b) using a signalling channel (508a and 508b), wherein each of the data processing systems may be authenticated using the authenticating 412 unit of the remote server 106 before establishing a connection. The routing unit 408 of the remote server 106 may obtain the IP addresses of each of the data processing systems and establish a connection between the data processing systems for an online meeting.

Upon establishing the connection, the first data processing system 102 may publish a first video stream 110. The first video stream 110 may comprise a video component obtained from a web camera and an audio component obtained from a microphone respectively of the first data processing system 102.

In one embodiment, the first digital client 214 of the first data processing system 102 may create a first publishing data channel 504 for the first video stream 110, wherein the first publishing data channel 504 may publish the first video stream 110 published by the first digital client 214.

In one embodiment, the first publishing data channel 504 may comprise a video track and an audio track, wherein each of the video track and the audio track of each publishing data channel forms a UDP socket 502c with the remote server 106 to publish the first video stream 110 from the first data processing system 102.

In one embodiment, the number of publishing data channels created by the first data processing system 102 may be based on the number of video streams shared by the first data processing system 102. As an example, if the first data processing system 102 shares three video streams, the first digital client may create three publishing data channels, wherein each publishing channel correspond to one video stream.

In one embodiment, the second digital client 316 of the second data processing system 104 may create a first receiving data channel 506 for the first video stream 110 published by the first data processing system 102, wherein the first receiving data channel 506 may receive the first video stream 110 published by the first digital client 214 of the first data processing system 102.

In one embodiment, the number of receiving data channels created by the second data processing system 104 may be based on the number of video streams shared by the first data processing system 102. As an example, if the first data processing system 102 shares three video streams, the second digital client may create three publishing channels, wherein each receiving data channel correspond to one video stream.

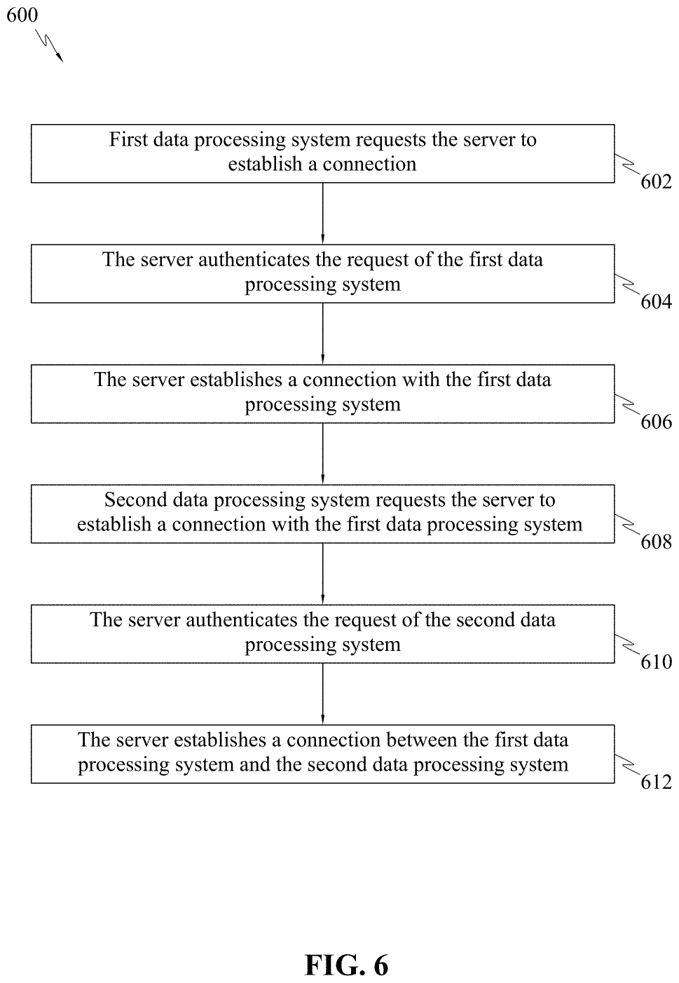

FIG. 6 is a flowchart of establishing a connection between the first data processing system 102 and the second data processing system 104. At step 602, the first data processing system 102 may request the remote server 106 to establish a connection. The first data processing system 102 may send a series of messages or commands requesting the remote server 106 to establish a connection.

At step 604, the remote server 106 may receive the request from the first data processing system 102 and may authenticate the request using the authenticating unit 412.

At step 606, after successful authentication, the remote server 106 may establish a connection with the first data processing system 102 via the signalling channels (508a and 508b).

At step 608, the second data processing system 104 may request the remote server 106 to establish a connection with the first data processing system 102. As an example, the second data processing system 104 may provide an online meeting identifier for connecting with the first data processing system 102.

At step 610, the remote server 106 may authenticate the request received from the second data processing system 104 using the authenticating unit 412.

At step 612, after successful authentication, the remote server 106 may establish a connection between the first data processing system 102 and the second data processing system 104 using the signalling channels (508a and 508b).

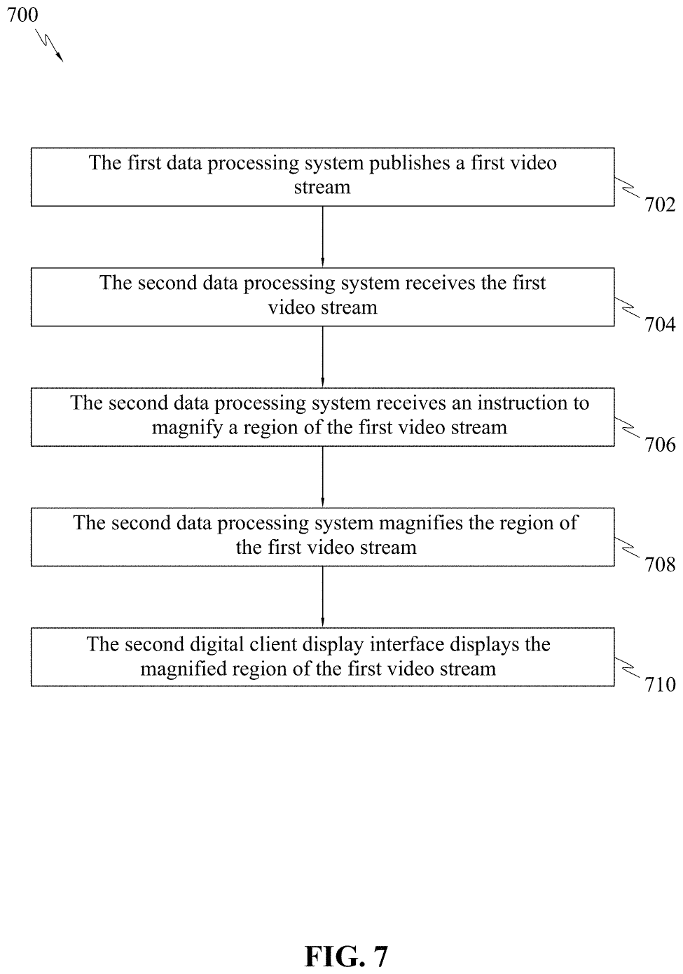

FIG. 7 is a flow chart of magnification of a region of a first video stream 110, in accordance with an embodiment. At step 702, the first data processing system 102 may publish a first video stream 110 with the second data processing system 104 via the server 106. The first video stream 110 may be obtained from a camera associated with the first data processing system 102.

In one embodiment, the first data processing system 102 may be configured to publish more than one video stream with the second data processing system 104

At step 704, the second data processing system 104 may receive the first video stream 110 published by the first data processing system 102. The second data processing system 104 may display the received first video stream 110 on the second digital client display interface of the second data processing system 104.

In one embodiment, the second data processing system 104 may receive multiple video streams published by the first data processing system 102. Further, the second data processing system 104 may display the received multiple video stream in individual display windows on the second digital client display interface.

At step 706, the second data processing system 104 may receive an instruction from a user associated with the second data processing system 104. The instruction may pertain to magnifying a region of the first video stream 110 that is displayed on the second digital client display interface.

In one embodiment, the user associated with the second data processing system 104 may provide the instruction to the second data processing system 104 using an input device 314.

At step 708, the second data processing system 104 may magnify the region of the first video stream 110 as instructed by the user associated with the second data processing system 104.

At step 710, the second data processing system 104 may display the magnified region of the first video stream 110 on the second digital client display interface.

In one embodiment, the magnified region of the first video may occupy the display window that displays the first video stream 110.

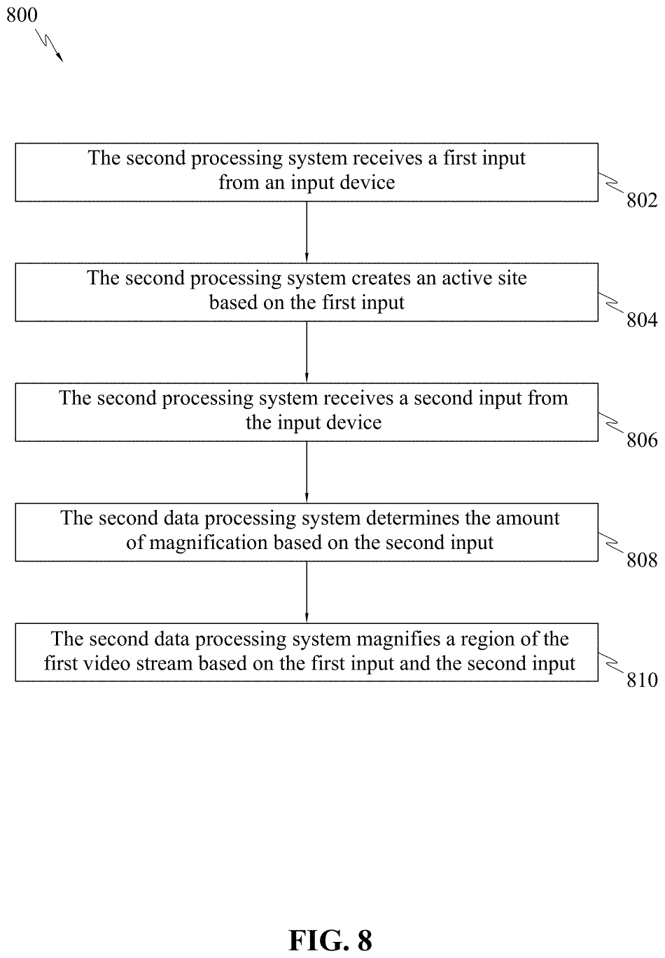

FIG. 8 is a flow chart of magnification of the region of a video stream, in accordance with an embodiment. At step 802, the second data processing system 104 may receive a first input from the user via the input device 314. The first input may comprise information related to a region of the first video to be magnified.

In one embodiment, the input device 314 may be a mouse that is connected to the second data processing system 104. The input device 314 may create a pointer image on the first video stream 110 that is displayed on the second digital client display interface. The position of the pointer image may be changed by changing the orientation of the input device 314. As an example, by moving the mouse, the position of the pointer image displayed on the second digital client display interface may be changed.

In another embodiment, the input device 314 may be a touchscreen that is connected to the second data processing system 104. The user may select a region of the first video to be magnified by touching the region of the first video stream 110 displayed on the second digital client display interface.

In one embodiment, when multiple video streams are displayed in multiple display windows on the second digital client display interface, the second processor module 302 may determine a video and a region of the video that is to be magnified. As an example, the user may move the mouse in a manner that the pointer image is positioned within a display window that displays the video stream that is to be magnified.

At step 804, the second processing module 302 may create an active site on the first video stream 110 displayed on the second digital client display interface based on the first input received from the user. The active site may relate to the region of the first video stream 110 to be magnified.

In one embodiment, the active site may be formed around the region of the pointer image of the input device 314 that is displayed on the first video stream 110. The user can change the active site (region of the first video stream 110 to be magnified) by changing the orientation of the mouse.

In another embodiment, the active site may be formed around the region where the user has provided a touch input in a touchscreen based input device 314.

At step 806, the second data processing system 104 may receive a second input from the user via the input device 314. The second input may relate to the amount of magnification to be performed in the selected region of the first video stream 110.

In one embodiment, the user may provide the second input using a wheel provided on the mouse. By scrolling the wheel of the mouse the user may determine the amount of magnification to be performed on the select region of the first video stream 110 that is to be magnified.

In another embodiment, the user may make a gesture on the touchscreen to magnify the region of the first video stream 110. The gesture may be pressing two fingers together on the touchscreen and moving them away from each other as if stretching them apart.

At step 808, the second data processing system 104 upon receive the second input from the user via the input device 314 and determine the amount of magnification to be performed based on the received second input.

At step 810, the second data processing system 104 may magnify the region of the first video stream 110 that is displayed on the second digital client display interface. The second data processing system 104 may magnify the region of the first video stream 110 based on the first input and the second input received from the user via the input device 314. The first input may relate to the region to be magnified and the second input may relate to the amount of magnification to be performed.

In one embodiment, when multiple video streams are displayed on the second digital client display interface, the second processor may determine the region of a specific video stream to be magnified and the amount of magnification to be performed based on the first input and second input received from the user via the input device 314.

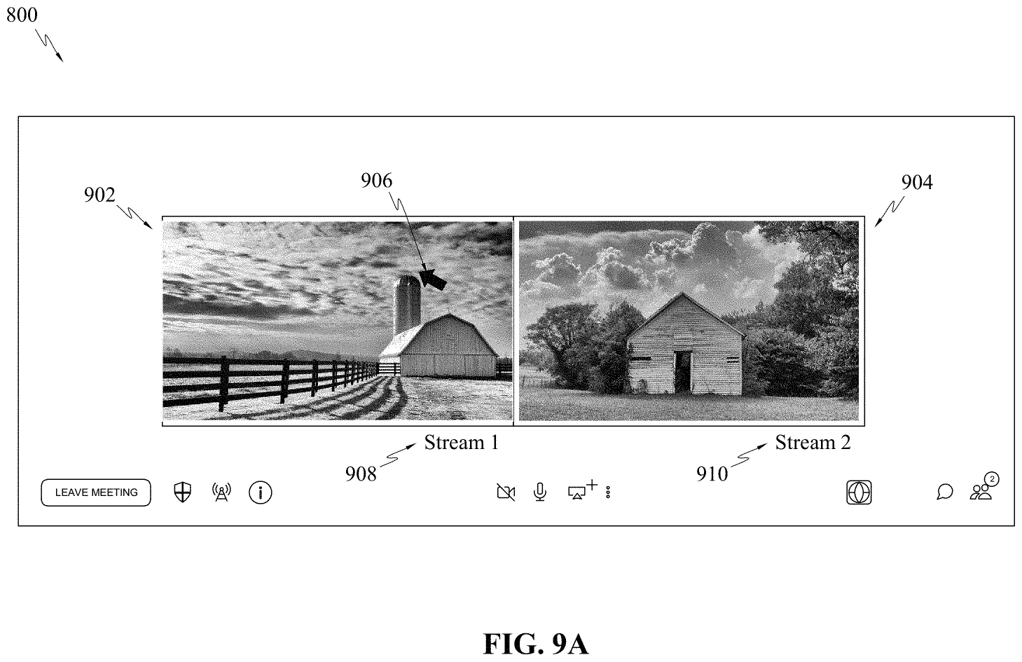

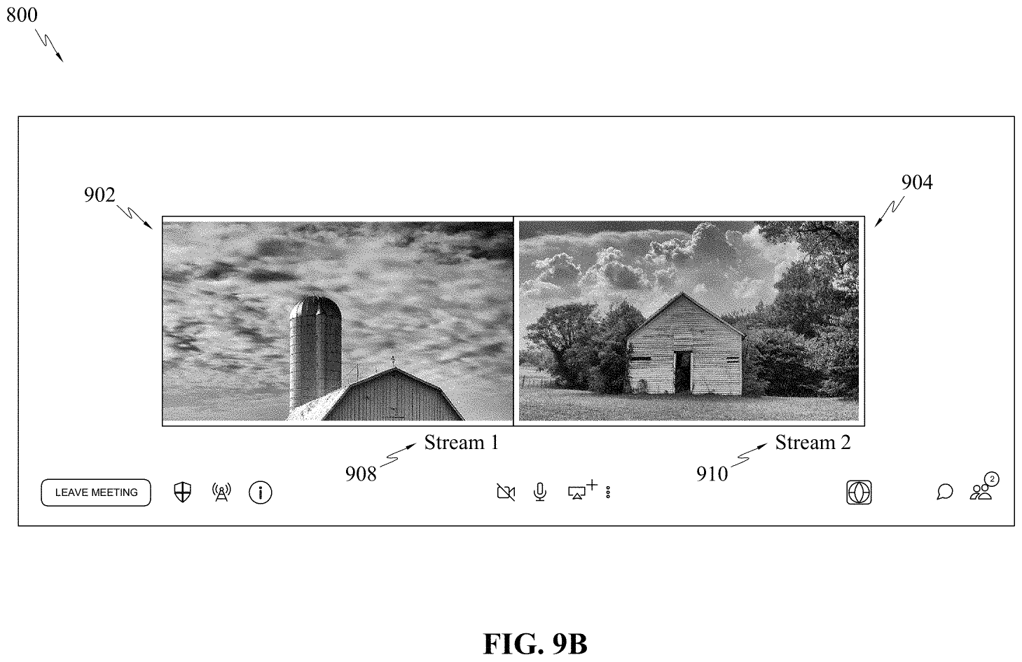

FIGS. 9A and 9B illustrates the second digital client display interface during the magnification of a region of a first video stream 110, in accordance with an embodiment. Referring to FIG. 9A, the second digital client display interface may display a first video stream 902 and a second video stream 904 shared by the first data processing system 102. A pointer image 906 may be created and displayed on the second digital client display interface. The position of the pointer image 906 may be changed by moving the input device 314 by the user. The position of the pointer image 906 may denote a video and a region of the video to be magnified. In FIG. 9A, the pointer image 906 is within the display window of the first video stream 110 and based on the coordinates of the pointer image 906 an active region may be determined. Further, the user may provide a second input via the input device 314 to determine the amount of magnification to be performed. Upon receiving the first input and second input the second processor module 302 may magnify the selected region of the first video stream 110.

Referring to FIG. 9B, the selected region of the first video stream 110 may be magnified and the magnified region may be displayed within the display window of the first video stream 902.

In one embodiment, the second processor module 302 may be configured to mute the audio of the video streams upon receiving an instruction from the user associated with the second data processing system 104.

In one embodiment, the server 106 may be configured to create an identity (refer FIG. 9A, 908 and 910) for each of the video streams shared by the first digital client. Further, the server 106 may be configured to communicate the identity for each of the video streams shared by the first digital client to the second digital client. The second processor module 302 may cause the second digital client to display the identity of the screens correlated with the respective display windows of the second digital client display interface.

In one embodiment, the identities created by the server 106 are unique compared to each other.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system enabling magnification of a video stream during an online event, the system comprising:
a first data processing system comprising a first processor module and a first digital client, the first processor module causing the first digital client to share at least a first video stream; and
a second data processing system comprising a second processor module and a second digital client;
wherein,
the first digital client shares the first video stream with the second data processing system;
the second digital client comprises a second digital client display interface, wherein the second digital client displays in the second digital client display interface, visual content of the first video stream in a display window; and
the second processor module is configured to:
receive an instruction from a user associated with the second data processing system, wherein the instruction comprises information related to a region of the first video stream to be magnified; and
magnify the region of the first video stream based on the instruction provided by the user; and
cause the second digital client display interface to display the magnified region of the first video stream in the display window.

2. The system of claim 1, wherein,
the first video stream comprises a video component and an audio component, wherein the video component is obtained from a first camera and the audio component is obtained from a first microphone connected to the first data processing system.

3. The system of claim 1, further comprising a remote server module, wherein, the first data processing system is connected to the remote server module;
the second data processing system is connected to the remote server module; and
the server module coordinates sharing of the first video stream from the first data processing system to the second data processing system.

4. The system of claim 3, wherein,
the first processor module causes the first digital client to create a first publishing data channel for the first video stream shared by the first digital client, wherein the first publishing data channel comprises a video track and an audio track;
the second processor module causes the second digital client to create a first receiving data channel for the first video stream shared by the first digital client, wherein the second receiving data channels comprises an video track and an audio track, wherein the second receiving channels receives the first video stream shared by the first digital client.

5. The system of claim 1, wherein the second data processing system comprises an input device for receiving the instruction from the user associated with the second data processing system, wherein the second processor module is configured to:
receive a first input from the user via the input device; and
create an active site on the first video stream displayed on the second digital client display interface based on the first input from the user.

6. The system of claim 5, wherein the second processor module is configured to create and display a pointer image on the active site on the second digital client display interface, wherein the position of the pointer image on the second digital client display interface is changed by changing the orientation of the input device by the user thereby changing the position of the active site.

7. The system of claim 6, wherein the second processor module is configured to receive from the user via the input device, a second input, wherein the second input pertains to the amount of magnification to be performed on the region of the first video stream to be magnified.

8. The system of claim 7, wherein the second processor module is configured to:
determine the active site on the second digital display client based on the position of the pointer image, wherein the active site pertains to the region of the first video stream to be magnified; and
magnify the visual content within the active site based on the second input received from the user.

9. The system of claim 1, wherein the second processing module is configured to mute the audio of the first video stream that is displayed on the second digital client display interface based on a mute request from the user.

10. The system of claim 1, wherein:
the first processor module is configured to cause the first digital client to share multiple video streams with the second data processing system; and
the second digital client displays in the second digital client display interface, visual content of each of the shared multiple video streams in individual display windows.

11. The system of claim 10, wherein the second processing module is configured to:
receive the instruction from the user associated with the second data processing, wherein the instruction comprises information related to a region of a specific video stream, among the multiple video streams, to be magnified; and
magnify the region of the specific video stream based on the instruction provided by the user; and
cause the second digital client display interface to display the magnified region of the specific video stream in the display window.

12. The system of claim 10, wherein the second data processing system comprises an input device for receiving the instruction from the user associated with the second data processing system, wherein the second processor module is configured to:
receive a first input from the user via the input device, to select a specific video stream and a region of the specific video stream to be magnified; and
create an active site on the specific video stream displayed on the second digital client display interface based on the first input from the user.

13. The system of claim 12, wherein the second processor module is configured to create a pointer image on the active site on the second digital client display interface, wherein the position of the pointer image on the second digital client display interface is changed by changing the orientation of the input device by the user thereby changing the position of the active site.

14. The system of claim 13, wherein the second processor module is further configured to receive from the user via the input device, a second input, wherein the second input pertains to the amount of magnification to be performed on the region of the specific video stream to be magnified.

15. The system of claim 14, wherein the second processor module is configured to:
select a specific video stream and determine the active site on the specific video stream displayed on the second digital display client based on the position of the pointer image, wherein the active site pertains to the region of the specific video stream to be magnified; and
magnify the visual content within the active site based on the second input received from the user.

16. The system of claim 10, wherein the second processing module is configured to selectively mute the audio of the individual video streams that is displayed on the second digital client display interface based on a mute request from the user.

17. The system of claim 10, the system comprises a remote server module, wherein,
the first data processing system is connected to the remote server module;
the second data processing system is connected to the remote server module; and
the server module coordinates sharing of the multiple video streams from the first data processing system to the second data processing system.

18. The system of claim 17, wherein the remote server module is configured to create an identity for each of the video streams shared by the first digital client;
the remote server module is configured to communicate the identity for each of the video streams shared by the first digital client to the second digital client; and
the second processor module causes the second digital client to display the identity of the screens correlated with the respective display windows of the second digital client display interface.

19. The system of claim 18, wherein each of the identities are unique compared to each other.
